(19) United States
(12) Patent Application Publication
(10) Pub. No.: US 2007/0041799 A1
(43) Pub. Date: Feb. 22, 2007

(54) Tap safety cover

(76) Inventors: Robert H. Schaefer, Lakeview, OH (US); Michael R. Schaefer, Lewistown, OH (US); Bonnie J. Schaefer, Lakeview, OH (US)

Correspondence Address: LITMAN LAW OFFICES, LTD, PO BOX 15035, CRYSTAL CITY STATION, ARLINGTON, VA, 22215, US

(21) Appl. No.: 11/207,953

(22) Filed: Aug. 22, 2005

(51) Int. Cl. B23B 49/02

(52) U.S. Cl. 408/97

(57) ABSTRACT

The tap safety cover conceals a rotating tap or the like to prevent a worker from contacting the sharp cutting edges of the tool during operation. The device includes a tool holder which secures in the chuck or bit holder of a rotary power tool. A hollow cylindrical barrel is affixed to the tool holder, with an extension sleeve telescoping from the barrel. The tap extends concentrically through the tool holder, barrel, and sleeve, and is completely covered when the sleeve is extended. A coil spring in the barrel urges the sleeve to a fully extended position, with the sleeve retracting as it is pushed back by the workpiece as the tap penetrates a previously drilled hole in the workpiece.

### BACKGROUND OF THE INVENTION

1. Field of the Invention

The present invention relates generally to safety guards and protective devices in the machining industry. More specifically, the present invention is a tap safety cover comprising a tap holder with a telescoping tubular safety cover that completely surrounds a tap during the hole threading operation to protect workers from contact with the sharp flutes of the tap as it rotates at potentially high speeds, thereby preventing injury.

2. Description of the Related Art

The forming of threaded holes is an essentially universal requirement in practically all areas of manufacturing, and in many other fields as well. Such threads are formed by means of taps having the desired thread diameter, which cut threads as they are screwed into the previously formed hole. This process may be done by hand for a relatively few threaded holes, but is commonly accomplished by high speed rotating machinery in major manufacturing facilities, such as automotive assembly plants and the like, in order to save time during the operation. Rotary power tools used in such high speed tapping operations can exceed nine thousand revolutions per minute (rpm), depending upon the machinery and operation.

A problem with the use of high-speed rotary machinery for driving taps is that a potential exists for serious injury if a worker comes into contact with the sharp threaded edge of one of the flutes of the tap while it is rotating at high speed. Even a work glove or clothing may catch or snag on the fluted tap edge, with the result being nearly instant injury to the worker, much faster than he or she can react. While such injuries are rare, the potential exists, and the potential for lost time, worker's compensation costs, etc., are significant.

Accordingly, various devices have been developed in the past to guard and protect workers during such machining operations. Most such devices are secured to the stationary housing of the rotary tool, and thus do not rotate with the drill bit or tap. Such relatively stationary devices tend to be at least somewhat complex, due to the requirement to secure the device to various differently shaped and configured housings for different tools. Where simpler rotary guards and guides are provided, they generally include external springs to return the axially moving or telescoping tube or component to its at rest position when no drilling or tapping operation is taking place. Such an external spring or the like on a rapidly rotating bit or tap can also snag or catch on another object, just as the flutes of a tap or drill bit may. Moreover, the present inventors are unaware of any such devices that also secure the rotating cutting tool (drill bit or tap) within the guard so that the guard also acts as a tool or bit holder, thus providing a more positive and rigid assembly between the cutting tool and the guard or cover.

Another loosely related class of devices comprises depth gauges and the like, which attach to rotary tools to indicate or limit the depth of a hole being formed. An example of such is found in German Patent No. 3,801,141, published on Jul. 27, 1989. This device attaches to the drill housing and has an axially offset measuring rod and stop that telescopes into a housing along the drill housing. No means of securing the drill bit in the rotary tool or guard function is provided.

None of the above inventions and patents, taken either singly or in combination, is seen to describe the instant invention as claimed. Thus, a tap safety cover solving the aforementioned problems is desired.

### SUMMARY OF THE INVENTION

The tap safety cover is a telescoping cylindrical device that is secured within the chuck or tool holder of a rotary working tool, and in turn secures the tap concentrically aligned with the rotary axis of the tool. The safety cover includes a fixed barrel and telescoping extension sleeve, with the tap passing through both the barrel and extension sleeve. The sleeve is biased or urged toward a fully extended state in which the drive end, barrel, and sleeve essentially cover the entire length of the tap by a coil spring disposed within the barrel and surrounding the installed tap. The spring preferably has a conical configuration, i.e., one end has a slightly larger diameter than the other. This allows the spring's coils to nest slightly within one another, thereby allowing the spring to compress more completely than a helical coil spring having constant diameter coils in which the coils rest directly atop one another at full compression. A conical spring is also more stable than a constant diameter spring when compressed and does not cock laterally to bind against the tap within the barrel, as can a constant diameter helical spring.

These and other features of the present invention will become readily apparent upon further review of the following specification and drawings.

### BRIEF DESCRIPTION OF THE DRAWINGS

FIG. 1 is an environmental side elevation view of a tap safety cover according to the present invention, showing its installation and use with a rotary power tool.

FIG. 2 is an environmental side elevation view in section of the tap safety cover with a tap shown installed therein in its entirety.

FIG. 3 is an exploded perspective view of the tap safety cover, showing further details thereof.

FIG. 4 is a detailed diagrammatic side elevation view of a tap having a conical coil spring therearound, illustrating the action of such a conical spring.

FIG. 5 is a prior art detailed diagrammatic side elevation view of a tap having a conventional constant diameter helical coil spring therearound, showing the problems which are encountered when using such a spring configuration with the present tap cover.

Similar reference characters denote corresponding features consistently throughout the attached drawings.

### DETAILED DESCRIPTION OF THE PREFERRED EMBODIMENT

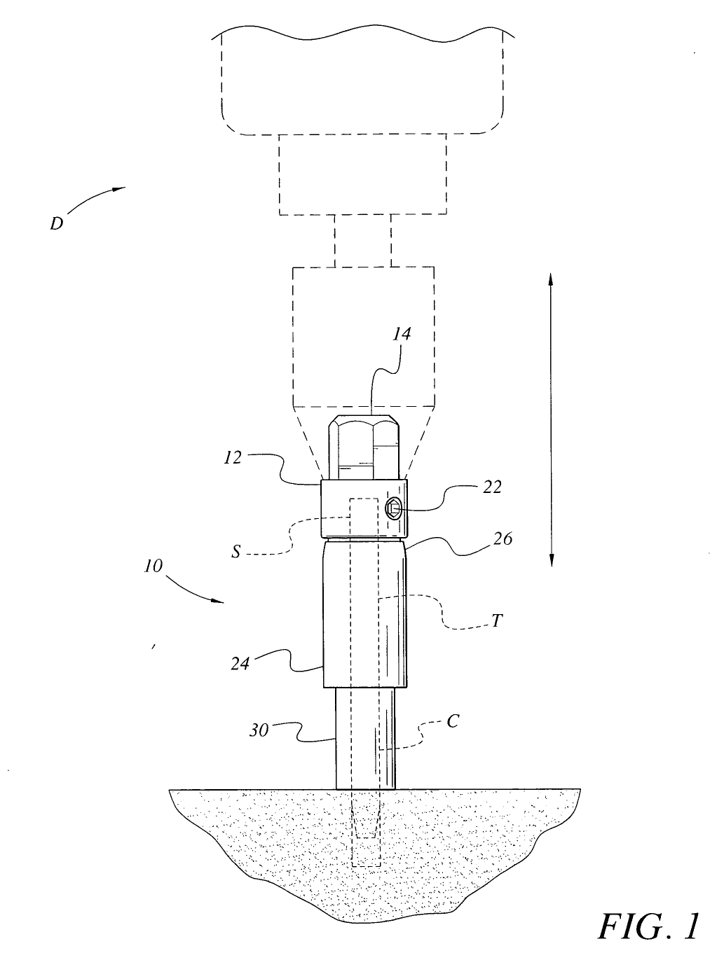

The present invention comprises a tap safety cover that completely encloses a thread cutting tap to protect a user from potential contact with the cutting edges of the tap, particularly in high speed thread cutting operations. FIG. 1 provides an environmental view of the present tap safety cover 10 as it would appear when chucked in a power driving tool D (shown in broken lines in FIG. 1) with a tap T (also shown in broken lines) secured within the safety cover 10.

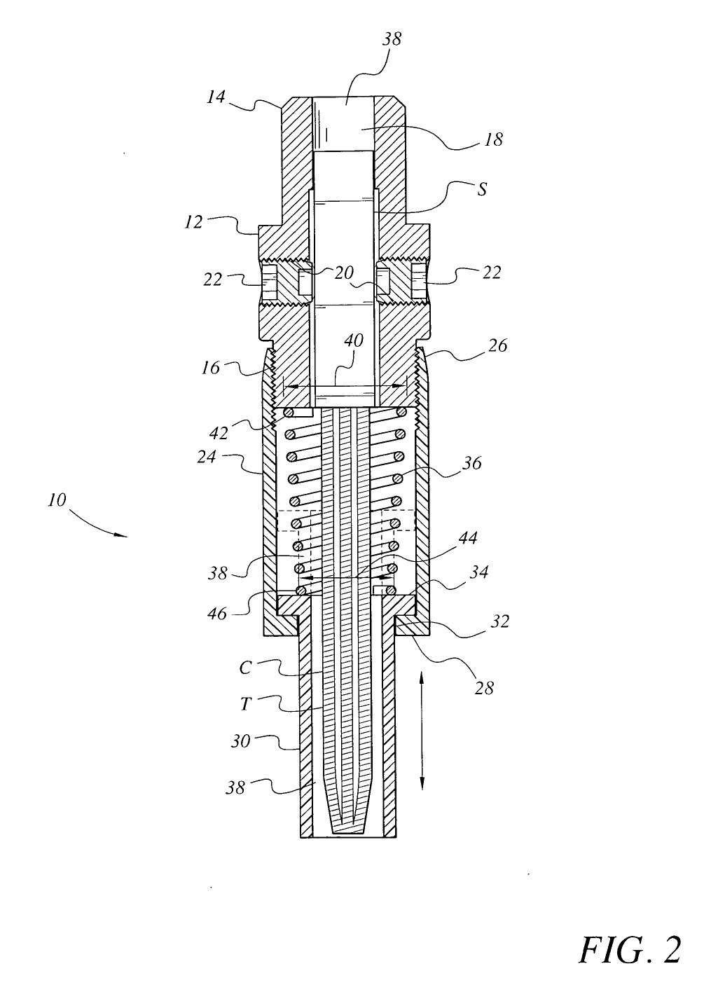

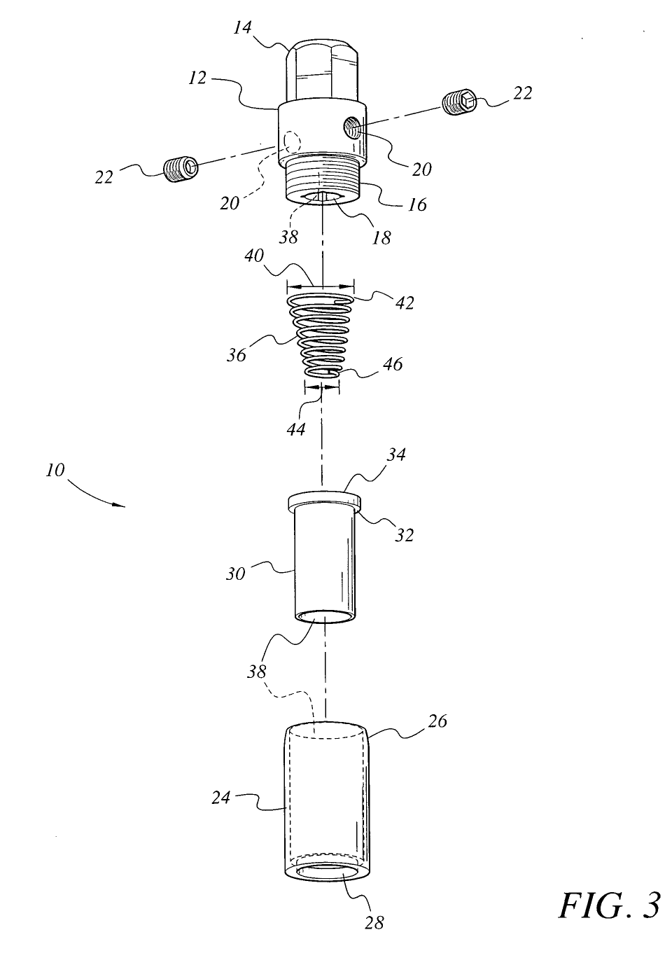

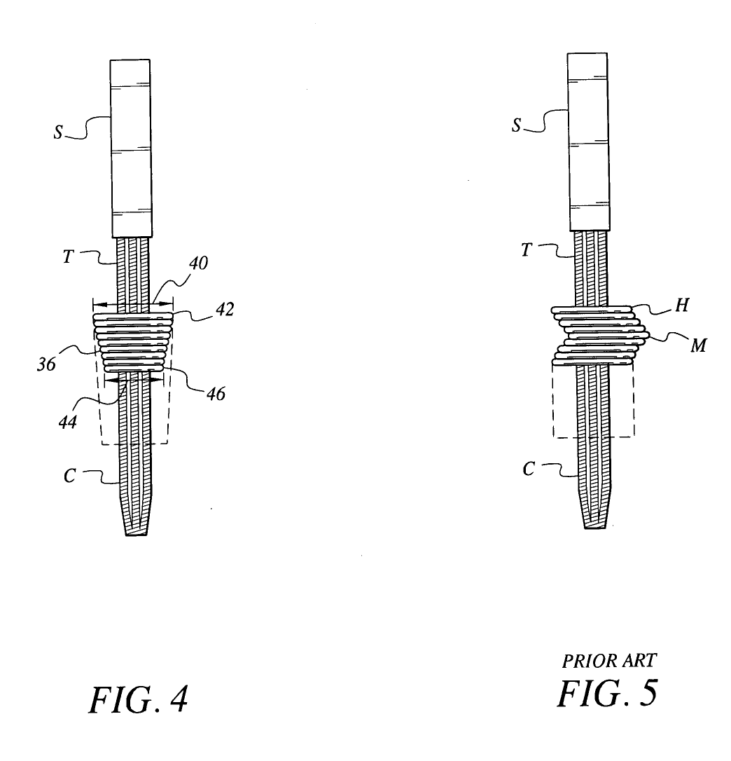

As shown in FIGS. 1-3, the safety cover 10 essentially comprises four basic components. A tool bit holder 12 has a shank or power tool attachment end 14 for chucking in an appropriate power driving tool D. The tool attachment end 14 preferably has a hexagonal cross section, as indicated from the views of FIGS. 1 and 3, but may have any suitable circular or non-circular cross section, as desired. The opposite barrel attachment end 16 of the tool bit holder is externally threaded, as shown in FIGS. 2 and 3, to mate with a barrel or sleeve, discussed further below.

A concentric tool bit attachment passage 18 is formed completely through the tool bit holder 12, with the tool attachment passage 18 being configured to accept and closely fit the drive end shank S of the tap T. Taps conventionally have square cross section driving ends, and the tool bit passage 18 of the tool bit holder 12 preferably includes such a square cross section, as indicated in FIGS. 2 and 3. The central portion of the tool bit holder 12 includes at least one, and preferably two, radially disposed and internally threaded tap locking setscrew passages 20 therein, as shown in FIGS. 2 and 3. A corresponding number of externally threaded tap locking setscrews 22 are installed in the setscrew passages 20 for adjustable tightening against the drive shank S of the tap T to secure the tap within the tool bit holder 12. Thus, the tap T (or other rotary tool bit) is not directly secured to the power driving tool D when using the present tap safety cover 10, but rather is secured within the tool bit holder portion 12 of the device, with the tool bit holder portion 12 in turn being secured in the rotary power tool D. The tool holder portion 12 of the device is preferably formed of tool steel, or other hard steel material such as corrosion resistant (stainless) steel, etc.

A hollow, cylindrical barrel 24 has an internally threaded tool bit attachment end 26, which mates with the externally threaded barrel attachment end 16 of the tool bit holder 12. The barrel 24 and tool bit holder 12 are rotationally fixed relative to one another when assembled together and when in use. The opposite end of the barrel 24 includes an internally facing flange 28, e.g., an annular flange, which serves to limit the travel of the extension sleeve installed therein, discussed further below. The internal diameter of the barrel 24 is sufficient to allow clear passage of the tap T concentrically therethrough, and also to provide clearance for a coil spring surrounding the tap T. The barrel 24 does not have any high forces or pressures acting thereon, e.g., pressure from tool holding set screws or drive tool chucks, etc., and may be formed of various strong plastic materials as desired. Alternatively, the barrel 24 may be formed of various metals, if so desired.

A hollow, cylindrical extension sleeve 30 is slidingly captured within the barrel 24, and extends to surround and completely cover the thread cutting portion C of the tap T when in use. The upper or barrel attachment end 32 of the extension sleeve 30 includes an outwardly extending flange 34, which has a diameter greater than the internal diameter of the inwardly oriented flange 28 of the barrel 24. The interaction of the two flanges 28 and 34 thus retains the extension sleeve 30 within the barrel 24 and prevents the extension sleeve 30 from escaping. As the tap T is threaded increasingly more deeply into the workpiece, the extension sleeve 30 bears against the workpiece and is pushed upwardly into the barrel 24, thus continually covering the cutting portion C of the tap T, generally as shown in FIG. 1. The extension sleeve 30, like the barrel 24, has no extreme forces or pressures imposed thereon and may be formed of plastic material, if so desired. Alternatively, metal may be used to form the sleeve 30, if so desired.

A coil spring 36 is captured within the barrel 24, between the barrel attachment end 16 of the tool bit holder 12 and the flange 34 of the extension sleeve 30. The spring 36 is in light compression, to urge the extension sleeve 30 outwardly from the barrel 24 to its maximum extent. The coil spring 36, extension sleeve 30, barrel 24, and tool bit holder 12 are all assembled concentrically with one another, and define a concentric tap installation or tool bit passage 38 therethrough when assembled. In the embodiment shown in the drawings, the spring 36 has a slightly conical configuration, with at least a slightly larger diameter 40 at its tool bit end 42 than the diameter 44 of its opposite extension sleeve end 46. This provides at least two benefits, due to the slight “nesting” of each of the smaller diameter coils within the adjacent slightly larger diameter coil.

First, this provides greater stability for the spring configuration when it is compressed, particularly as it reaches its “solid,” fully compressed state. Each successive smaller diameter coil cannot slip past the slightly larger diameter of the next larger coil, as it is captured slightly within the next larger diameter coil, rather than riding directly atop the curved surface of the next coil. In contrast, the medial coils M of the constant diameter helical spring H shown in FIG. 5 tend to “cock” laterally as the spring H is compressed. This is because there is no lateral restraining force on the coils, other than the continuous linear connection of the coils to one another. As such a constant diameter, helical spring H is compressed, particularly as it reaches its “solid” fully compressed state, the coils tend to slip laterally past one another. This results in the medial portion M of such a spring H squeezing out laterally to the side and binding upon the cutting portion C of the tap T passing concentrically therethrough. This interferes with the extension of the sleeve 30 when the tap T is removed from the workpiece, potentially exposing the cutting portion C of the tap T, and the constant diameter helical coil spring either may not work in the tap safety cover 10 of the present invention, or may not work as well as the tapered, conical compression spring 36.

The second advantage of the conical spring is also due to the slight nesting of each smaller diameter coil within the adjacent slightly larger diameter coil. This reduces the overall compressed length of the conical spring in comparison to a constant diameter helical spring H, as the coils do not rest directly atop one another as they do with a helical spring.

In conclusion, the present tap safety cover greatly improves safety when working with high-speed taps, and may be adapted to other high-speed rotary cutting tools (drills, etc.) as well. The extension sleeve completely covers the cutting portion of the tap when the tap is properly installed within the safety cover, assuring that the hand or clothing of a machinist working with such a high-speed tool cannot come into contact with the cutting edge of the tap during operation. The complete coverage of the tap during thread cutting operations also captures chips from the cutting process, thus providing further safety for the machinist or worker performing the thread cutting operation or working in the vicinity of such an operation. The improvement in safety provided by the present safety cover will be much appreciated in the workplace, and will quickly pay for itself in terms of reduced injury claims and lost time due to injuries on the job.

It is to be understood that the present invention is not limited to the embodiment described above, but encompasses any and all embodiments within the scope of the following claims.

We claim:

1. A tap safety cover, comprising:
a tool bit holder having a tool bit attachment passage disposed concentrically therethrough, a power tool attachment end, and a barrel attachment end opposite the power tool attachment end;
a hollow, cylindrical barrel extending concentrically from the barrel attachment end of said tool bit holder;
a hollow, cylindrical extension sleeve slidingly captured within said barrel and partially extendable from said barrel; and
a spring disposed within said barrel between the barrel attachment end of said tool bit holder and said extension sleeve, said tool bit holder, said barrel, said extension sleeve, and said coil spring all defining a concentric tap installation passage therethrough.

2. The tap safety cover according to claim 1, wherein:
said spring has a tool bit end and an extension sleeve end opposite the tool bit end; and
said spring is a coil spring having a conical configuration, the tool bit end of said spring having a larger diameter than the extension sleeve end of said spring.

3. The tap safety cover according to claim 1, wherein:
the power tool attachment end of said tool bit holder defines a shank having a hexagonal cross section adapted for gripping by a chuck of a power tool; and
the tool bit attachment passage of said tool bit holder has a square cross section adapted for receiving a shank of a tap.

4. The tap safety cover according to claim 1, wherein:
the barrel attachment end of said tool bit holder is externally threaded; and
said barrel has an internally threaded tool bit holder attachment end mating with the externally threaded barrel attachment end of said tool bit holder.

5. The tap safety cover according to claim 1, wherein said tool bit holder has at least one radially disposed, internally threaded tap locking setscrew passage defined therein, the tap safety cover further comprising a tap locking setscrew adjustably threaded into the at least one tap locking set screw passage.

6. The tap safety cover according to claim 1, wherein:
said tool bit holder is formed of steel; and
said barrel and said extension sleeve are formed of plastic.

7. A tap safety cover, comprising:
a tool bit holder having a tool bit attachment passage disposed concentrically therethrough, a power tool attachment end, and a barrel attachment end opposite the power tool attachment end;
a hollow, cylindrical barrel extending concentrically from the barrel attachment end of said tool bit holder;
a hollow, cylindrical extension sleeve slidingly captured within said barrel and extendable from said barrel; and
a conical coil spring disposed within said barrel between the barrel attachment end of said tool bit holder and said extension sleeve.

8. The tap safety cover according to claim 7, wherein:
said coil spring has a tool bit end and an extension sleeve end opposite the tool bit end;
the tool bit end of said coil spring has a larger diameter than the extension sleeve end thereof; and
said tool bit holder, said barrel, said extension sleeve, and said coil spring all define a concentric tap installation passage therethrough.

9. The tap safety cover according to claim 7, wherein:
the power tool attachment end of said tool bit holder has a hexagonal cross section; and
the tool bit attachment passage of said tool bit holder has a square cross section.

10. The tap safety cover according to claim 7, wherein:
the barrel attachment end of said tool bit holder is externally threaded; and
said barrel has an internally threaded tool bit holder attachment end mating with the externally threaded barrel attachment end of said tool bit holder.

11. The tap safety cover according to claim 7, wherein said tool bit holder has at least one radially disposed, internally threaded tap locking setscrew passage defined therein, the tap safety cover further comprising a tap locking setscrew adjustably threaded into the at least one tap locking setscrew passage for clamping a tap in said holder.

12. The tap safety cover according to claim 7, wherein:
said tool bit holder is formed of steel; and
said barrel and said extension sleeve are formed of plastic.

13. A tap safety cover in combination with a tap, comprising:
a tool bit holder having a tool bit attachment passage disposed concentrically therethrough, a power tool attachment end, and a barrel attachment end opposite the power tool attachment end;
a hollow, cylindrical barrel extending concentrically from the barrel attachment end of said tool bit holder, and rotationally affixed relative thereto;
a hollow, cylindrical extension sleeve slidingly captured within said barrel;
a spring disposed within said barrel between the barrel attachment end of said tool bit holder and said extension sleeve;
said tool bit holder, said barrel, said extension sleeve, and said coil spring all defining a concentric tap installation passage therethrough; and
a tap having a threaded cutting portion and a square drive end, the tap being removably attached to the holder and disposed within said tap installation passage.

14. The tap safety cover and tap combination according to claim 13, wherein:
said coil spring has a tool bit end and an extension sleeve end opposite the tool bit end; and
said coil spring has a conical configuration, the tool bit end of said spring having a larger diameter than the extension sleeve end of said spring.

15. The tap safety cover and tap combination according to claim 13, wherein:
the power tool attachment end of said tool bit holder has a hexagonal cross section; and
the tool bit attachment passage of said tool bit holder has a square cross section closely fitting the square drive end of said tap.

16. The tap safety cover and tap combination according to claim 13, wherein:
the barrel attachment end of said tool bit holder is externally threaded; and
said barrel further includes an internally threaded tool bit holder attachment end mating with the externally threaded barrel attachment end of said tool bit holder.

17. The tap safety cover and tap combination according to claim 13, wherein said tool bit holder has at least one radially disposed, internally threaded tap locking setscrew passage defined therein, the tap safety cover and tap combination further comprising a tap locking setscrew adjustably threaded into the at least one tap locking setscrew passage and bearing against the square drive end of said tap.

18. The tap safety cover according to claim 13, wherein:
said tool bit holder is formed of steel; and
said barrel and said extension sleeve are formed of plastic.
